(19) United States
(12) Patent Application Publication
(10) Pub. No.: US 2008/0278608 A1
(43) Pub. Date: Nov. 13, 2008

(54) Camera module

(75) Inventors: Byung Hoon Kim, Suwon (KR); Won Tae Choi, Hwasung (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/149,611

(22) Filed: May 5, 2008

(30) Foreign Application Priority Data
May 7, 2007 (KR) 10-2007-0044253

(51) Int. Cl. H04N 5/217

(52) U.S. Cl. 348/246; 348/E05.024

(57) ABSTRACT

There is provided a camera module including dual image sensors used for different purposes, which corrects optical defects of images imaged by the dual image sensors individually to suit purposes and processes the imaged images into image signals. The camera module includes: a plurality of image sensors imaging images with different optical properties from one another; a plurality of auxiliary image processors electrically connected to the plurality of image sensors, individually, the auxiliary image processors correcting different optical defects of the images from corresponding ones of the image sensors, respectively; and an image signal processing part selecting at least one of corrected images from the auxiliary image processors to process into an image signal capable of being displayed.

### CROSS-REFERENCE TO RELATED APPLICATIONS

This application claims the priority of Korean Patent Application No. 2007-44253 filed on May 7, 2007, in the Korean Intellectual Property Office, the disclosure of which is incorporated herein by reference.

### BACKGROUND OF THE INVENTION

1. Field of the Invention

The present invention relates to a camera module, and more particularly, to a camera module including dual image sensors used for different purposes from each other, which corrects optical defects of images imaged by the dual image sensors individually to suit purposes and processes the imaged images into image signals.

2. Description of the Related Art

Recently, mobile telecommunication service providers have implemented a high speed downlink packet access (HSDPA) nationwide. The HSDPA enables visual communication in which a person can talk visually with the other person using a mobile communication terminal such as a mobile phone and a personal digital assistant (PDA). In general, the mobile communication terminal includes an image sensor for imaging and particularly, an additional image sensor for visual communication to enable the visual communication. Hereinafter, a conventional camera module installed in the mobile communication terminal will be described with reference to FIG. 1.

FIG. 1 is a configuration view illustrating a conventional camera module.

Referring to FIG. 1, the conventional camera module includes a plurality of image sensors 11 and 12 and a plurality of image sensor processors (ISP) 21 and 22.

The plurality of image sensors include a first image sensor 11 imaging an image or storing the imaged image for general imaging use and a second image sensor 12 performing the visual communication as described above.

In the same manner as the plurality of image sensors, the plurality of image sensor processors include a first image processor 21 processing an electrical signal from the first image sensor 11 into an image signal and a second image processor 21 processing an electrical signal from the second image sensor 12 into an image signal.

As described above, the conventional camera module includes the first and second sensors 11 and 12 used for different purposes and the first and second image processors 21 and 22 processing the electrical signals from the first and second image sensors 11 and 12 into the respective image signals.

This conventional camera module, when installed on a board inside a mobile telecommunication terminal, occupies a significant area of inner space, thereby increasing bulk of the mobile telecommunication terminal.

### SUMMARY OF THE INVENTION

An aspect of the present invention provides a camera module including dual image sensors used for different purposes from each other, which corrects optical defects of images imaged by the dual image sensors individually to suit purposes and processes the imaged images into image signals.

According to an aspect of the present invention, there is provided a camera module including: a plurality of image sensors imaging images with different optical properties from one another; a plurality of auxiliary image processors electrically connected to the plurality of image sensors, individually, the auxiliary image processors correcting different optical defects of the images from corresponding ones of the image sensors, respectively; and an image signal processing part selecting at least one of corrected images from the auxiliary image processors to process into an image signal capable of being displayed.

The image signal processing part may include: a selector selecting the corrected image from the auxiliary image processors in response to a control signal; and a main image processor processing the corrected image from the selector into the image signal.

The camera module may further include a plurality of lenses optically connected to the plurality of image sensors, individually, the plurality of lenses receiving the images with different optical properties from one another.

The camera module may further include a plurality of color filters optically connected to the plurality of lenses, individually, the color filters filtering the images from the lenses with a preset color to transfer to corresponding ones of the image sensors, respectively.

The plurality of lenses may include: an imaging lens imaging and storing a corresponding one of the images and a visual communication lens imaging the other corresponding image for communication, the plurality of image sensors may include: an image sensor for imaging optically connected to the imaging lens and an image sensor for visual communication optically connected to the visual communication lens, and the plurality of auxiliary image processors may include: an auxiliary image processor for imaging correcting an optical defect of a corresponding one of the images from the image sensor for imaging and an auxiliary image processor for visual communication correcting an optical defect of the other corresponding image from the image sensor for visual communication.

The plurality of auxiliary image processors may correct color shade of the images in the optical defects of the images.

The plurality of auxiliary image processors may correct dead pixels of the images in the optical defects of the images.

The image sensor for imaging and the auxiliary image processor for imaging may be formed of a first integrated circuit and the image sensor for visual communication, and the auxiliary image processor for visual communication may be formed of a second integrated circuit.

The camera module may further include: a board having one surface and another surface opposing the one surface, wherein the first integrated circuit is disposed on the one surface of the board and the second integrated circuit is disposed on the another surface of the board, and each of the selector and the main image processor is disposed on one of the one surface and the another surface of the board.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view illustrating a conventional camera module;

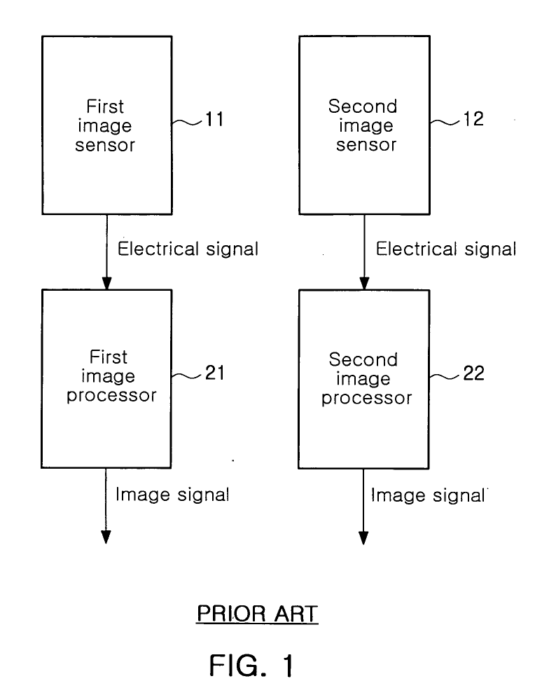

FIG. 2 is a configuration view illustrating a camera module according to an exemplary embodiment of the invention; and

FIG. 3 illustrates a camera module according to an exemplary embodiment of the invention.

### DETAILED DESCRIPTION OF THE PREFERRED EMBODIMENT

Exemplary embodiments of the present invention will now be described in detail with reference to the accompanying drawings.

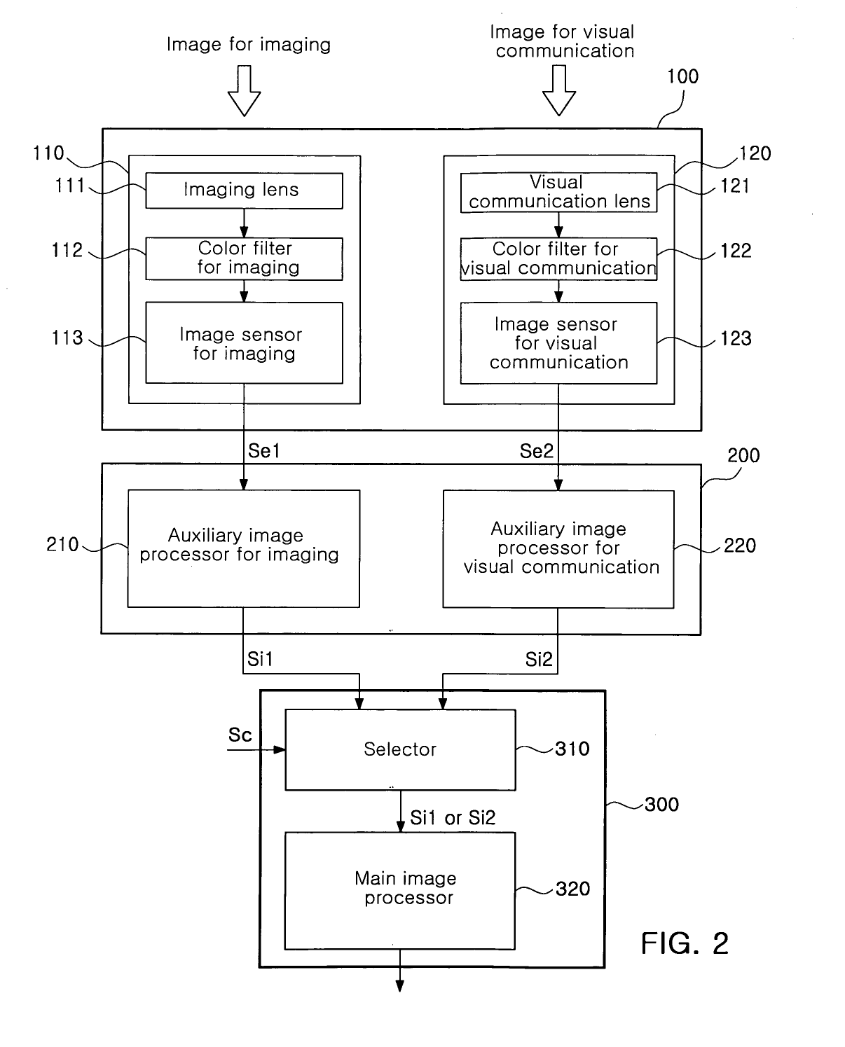

FIG. 2 is a configuration view illustrating a camera module according to an exemplary embodiment of the invention.

Referring to FIG. 2, the camera module of the present embodiment includes an image sensor part 100, an auxiliary image processing part 200, and an image signal processing part 300.

The image sensor part 100 includes a plurality of image sensor units 110 and 120. The image sensor units 110 and 120 include a lens group having a plurality of lenses 111 and 121, and a plurality of image sensors 113 and 123 corresponding to the plurality of lenses, respectively.

The plurality of lenses 111 and 121 of the lens group have optical properties different from each other and can image different images.

The images received from the plurality of lenses are transferred, respectively, to the plurality of image sensors 113 and 123 corresponding to the lenses. The image sensors 113 and 123 have optical properties different form each other.

A plurality of color filters 112 and 122 are disposed between the lenses and the image sensors to correspond to the lenses and the image sensors, respectively. The plurality of color filters 112 and 122 filter the images transferred from the corresponding lenses to the image sensors, respectively, with a preset color.

The image sensor part 100 can perform imaging function and visual communication function as well. For the imaging function, the image sensor part 100 images an image or stores the imaged image by virtue of a high speed downlink packet access (HSDPA) implemented by a mobile telecommunication service provider. Also, for the visual communication function, the image sensor part 100 images an image to be used for communication purpose.

That is, the plurality of lenses may include an imaging lens 111 receiving an image for imaging and a visual communication lens 112 receiving an image for visual communication.

As described above, the imaging lens 111 and the visual communication lens 112 are different from each other in terms of angle of view and curvature, thereby allowing the received images to be different in color information such as color or color tone.

Likewise, the plurality of image sensors may include the image sensor for imaging receiving the image from the imaging lens 111 and the image sensor for visual communication 122 receiving the image from the visual communication lens 121.

As described above, the image sensor for imaging 113 and the image sensor for visual communication 123 are different from each other in optical properties. For example, the image sensor for imaging 113 may have 2 million pixels and the image sensor for visual communication 123 may be formed of a common intermediate format (CIF) type, a quarter common intermediate format (QCIF) type, and a video graphics array (VGA) having 2,5000 pixels.

Accordingly, electrical signals Se1 and Se2 transferred from the image sensor for imaging 112 and the image sensor for visual communication 122 to the auxiliary image processing part contain information about the imaged image for imaging and information about the imaged image for visual communication, respectively.

The imaging lens 111 and the visual communication lens 121 may have optical defects in imaging the image. Also, the image sensor for imaging 113 and the image sensor for visual communication 123 may have optical defects.

That is, the imaging lens 111 and the visual communication lens 121 may mainly undergo color-related defects and the image sensor for imaging 113 and the image sensor for visual communication 123 may entail physically dysfunctional pixels as defects.

In consequence, each of the image information of the electrical signals Se1 and Se2 transferred from the image sensor for imaging 113 and the image sensor for visual communication 123, respectively may contain color information and pixel information having different optical defects between the two image information. Thus the camera module of the present embodiment inevitably includes auxiliary image processors correcting the optical defects different from each other, respectively.

The auxiliary image processing part 200 includes a plurality of auxiliary image processors 210 and 220. Also, the plurality of auxiliary image processors may include an auxiliary image processor for imaging 210 and an auxiliary image processor for visual communication 220.

The first electrical signal Se1 is transferred from the image sensor 113 for imaging to the auxiliary image processor for imaging 210, and the second electrical signal Se2 is transferred from the image sensor for visual communication 123 to the auxiliary image processor for visual communication 220.

As described above, the first electrical signal Se1 contains image information about the imaged image for imaging, color information about the imaging lens 111 and pixel information about the image sensor for imaging 113. Also, the electrical signal Se2 contains image information about the imaged image for visual communication, color information about the visual communication lens 121 and pixel information about the image sensor for visual communication 123.

Here, the auxiliary image processor for imaging 210 corrects optical defects resulting from the imaging lens 111 and the image sensor for imaging 113 out of the information contained in the first electrical signal Se1. That is, the auxiliary image processor for imaging 210 corrects color shade contained in the color information of the imaging lens 111 and corrects dead pixels contained in the pixel information of the image sensor for imaging 113.

In the similar manner, the auxiliary image processor for visual communication 220 corrects color information of the visual communication lens 121 and pixel information of the image sensor for visual communication 123 out of the information contained in the second electrical signal. That is, the auxiliary image processor for imaging 210 corrects color shade contained in the color information of the visual communication lens 121 and corrects dead pixels contained in the pixel information of the image sensor for visual communication 123.

The auxiliary image processor for imaging 210 transfers a first image signal Si1 containing corrected color information, and corrected pixel information and image information of the image for imaging to an image signal processing part 300. Likewise, the auxiliary image processor for visual communication 210 transfers corrected color information, and corrected pixel information and image information of the image for visual communication to the image signal processing part 300.

The image signal processing part 300 receives the first and second image signals Si1 and Si2 from the auxiliary image processor for imaging 210 and the auxiliary image processor for visual communication 220, respectively and processes the image signals into signals capable of being displayed. That is, the image signal processing part 300 processes the corrected color information, and corrected pixel information and image information into signals. In this case, the image signal processing part 300 performs various functions such as color interpolation, color correction, gamma conversion, auto exposure, auto focus and auto white balance. Specifically, the image signal processing part 300 produces original color for the imaged images using surrounding color through color interpolation function, corrects color difference of the imaged images through the color correction function, converts non-linear characteristics of the color of the imaged images into linear characteristics through the gamma conversion function, adjusts light amount of the imaged images through the auto exposure function, adjusts a focal point of the imaged images through the auto focus function and corrects difference in color temperature of the imaged images through the auto white balance function.

The image signal processing part 300 selects one of the first image signal Si1 and the second image signal Si2 transferred from the auxiliary image processor for imaging 210 and the auxiliary image processor for visual communication 220, respectively and processes the corrected color information, and corrected pixel information and image information contained in the selected image signal.

Accordingly, the image signal processing part 300 may include a selector 310 selecting one of the first and second image signals Si1 and Si2 from the auxiliary image processing part 200 in response to a control signal Sc. Also, the image signal processing part 300 may include a main signal processor 320 receiving the image signal from the selector 310 and performing the aforesaid signal-processing function of the image signal processing part 300. The control signal Sc can be transferred to the selector 310 by selecting the imaging function or the visual communication function through a key pad of a mobile telecommunication terminal where the camera module of the present embodiment is installed.

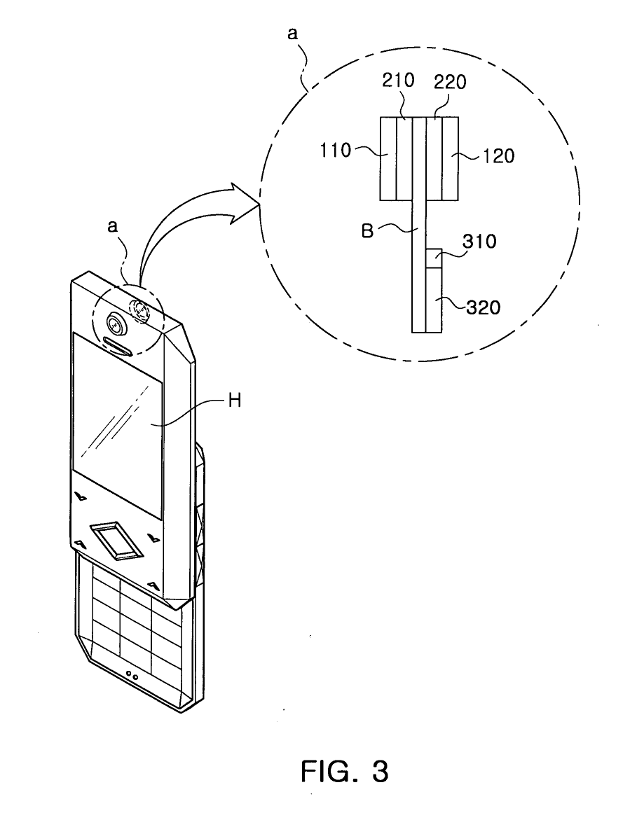

FIG. 3 illustrates a camera module according to an exemplary embodiment of the invention.

Referring to FIG. 3, the camera module of the present embodiment can be installed inside a mobile telecommunication terminal. The mobile telecommunication terminal having the camera module of the present embodiment installed thereon is illustrated in a lower part of FIG. 3. An image sensor for visual communication may be disposed in an upper part of a front of the mobile telecommunication terminal where a liquid crystal display (LCD) window is formed in order to allow a person to image his/her face to transmit to the other person. The image sensor for imaging may be located in an upper part of a rear side of the mobile telecommunication terminal.

The mobile telecommunication terminal where the camera module of the present embodiment is installed is illustrated in an upper part of FIG. 3 by an expanded perspective view. Referring to the drawing shown in the upper part of FIG. 3, the camera module of the present embodiment may be formed on a board B. The board B has one surface and another surface opposing the one surface. An image sensor for imaging unit 110 and an auxiliary image processor for imaging 210 may be disposed on the one surface and an image sensor for visual communication unit 120 and an auxiliary image processor for visual communication 220 may be disposed on the another surface.

The image sensor for imaging unit 110 and the auxiliary image processor for imaging 210 may be formed of one chip integrated circuit (IC). Likewise, the image sensor for visual communication unit 120 and the auxiliary image processor for visual communication 210 may be formed of another chip IC. In addition, each of a selector 310 and an image processor 320 may be disposed on one of the one surface and the another surface of the board B.

As set forth above, according to exemplary embodiments of the invention, a camera module includes an auxiliary image processor processing respective color information and pixel information of a plurality of lenses having optical properties different form one another, individually and a plurality of image sensors having pixel properties different from one another. This leads to reduction in size of a module. Moreover, in a case where the lenses and the image sensors are changed in characteristics, only replacement of the auxiliary image processor allows the camera module to perform its own function, thereby ensuring the camera module to be produced and repaired easily.

While the present invention has been shown and described in connection with the exemplary embodiments, it will be apparent to those skilled in the art that modifications and variations can be made without departing from the spirit and scope of the invention as defined by the appended claims.

What is claimed is:

1. A camera module comprising:
a plurality of image sensors imaging images with different optical properties from one another;
a plurality of auxiliary image processors electrically connected to the plurality of image sensors, individually, the auxiliary image processors correcting different optical defects of the images from corresponding ones of the image sensors, respectively; and
an image signal processing part selecting at least one of corrected images from the auxiliary image processors to process into an image signal capable of being displayed.

2. The camera module of claim 1, wherein the image signal processing part comprises:
a selector selecting the corrected image from the auxiliary image processors in response to a control signal; and
a main image processor processing the corrected image from the selector into the image signal.

3. The camera module of claim 2, further comprising a plurality of lenses optically connected to the plurality of image sensors, individually, the plurality of lenses receiving the images with different optical properties from one another.

4. The camera module of claim 3, further comprising a plurality of color filters optically connected to the plurality of lenses, individually, the color filters filtering the images from the lenses with a preset color to transfer to corresponding ones of the image sensors, respectively.

5. The camera module of claim 3, wherein the plurality of lenses comprise: an imaging lens imaging and storing a corresponding one of the images and a visual communication lens imaging the other corresponding image for communication,
the plurality of image sensors comprise: an image sensor for imaging optically connected to the imaging lens and an image sensor for visual communication optically connected to the visual communication lens, and
the plurality of auxiliary image processors comprise: an auxiliary image processor for imaging correcting an optical defect of a corresponding one of the images from the image sensor for imaging and an auxiliary image processor for visual communication correcting an optical defect of the other corresponding image from the image sensor for visual communication.

6. The camera module of claim 1, wherein the plurality of auxiliary image processors correct color shade of the images in the optical defects of the images.

7. The camera module of claim 6, wherein the plurality of auxiliary image processors correct dead pixels of the images in the optical defects of the images.

8. The camera module of claim 5, wherein the image sensor for imaging and the auxiliary image processor for imaging are formed of a first integrated circuit and the image sensor for visual communication and the auxiliary image processor for visual communication are formed of a second integrated circuit.

9. The camera module of claim 8, further comprising: a board having one surface and another surface opposing the one surface,
wherein the first integrated circuit is disposed on the one surface of the board and the second integrated circuit is disposed on the another surface of the board, and
each of the selector and the main image processor is disposed on one of the one surface and the another surface of the board.
